(19) United States
(12) Patent Application Publication
(10) Pub. No.: US 2014/0291991 A1
(43) Pub. Date: Oct. 2, 2014

(54) Method and Apparatus for Amplifying an Ambient Wind Stream to a Wind Turbine

(71) Applicants: William L. Kerr, JR., Columbiana, OH (US); Dennis Scott Meli, Canfield, OH (US); Edward A. Trolio, Boardman, OH (US)

(72) Inventors: William L. Kerr, JR., Columbiana, OH (US); Dennis Scott Meli, Canfield, OH (US); Edward A. Trolio, Boardman, OH (US)

(73) Assignee: Roth Renewable Energy, LLC, Youngstown, OH (US)

(21) Appl. No.: 14/241,527

(22) PCT Filed: Aug. 31, 2012
(86) PCT No.: PCT/US12/53286

§ 371 Date: Apr. 3, 2014

Related U.S. Application Data
(60) Provisional application No. 61/529,355, filed on Aug. 31, 2011.

(51) Int. Cl. F03D 9/00

(52) U.S. Cl. CPC F03D 9/002
USPC 290/55; 415/110

(57) ABSTRACT

A wind speed amplification device that cooperates with a wind turbine to amplify ambient wind speed conditions directed to the blades of the wind turbine. In one embodiment, the amplification device has a conical shape that is configured to generally overly the central hub associated with an axis of rotation of the blades. In another embodiment, the amplification device has a wedge shape that is positioned radially outboard of the operating footprint of the blades and extends upstream of the plane of operation of the turbine blades. In a preferred embodiment, the wedge shaped amplification device includes a forward wedge portion and a rearward wedge portion that extend in opposite directions relative to the plane of operation of the blades.

### CROSS-REFERENCE TO RELATED PATENTS

This application claims priority to U.S. Provisional Patent Application Ser. No. 61/529,355 filed on Aug. 31, 2011 titled “Method and Apparatus For Amplifying Wind Stream To A Wind Turbine” and the disclosure of which is expressly incorporated herein.

### BACKGROUND AND SUMMARY OF THE INVENTION

The present invention is directed to improving the performance of wind turbines and, more particularly, to increasing the electrical output generated by a wind turbine and doing so during low wind speed conditions.

Wind energy is increasingly being considered a viable alternative energy source for providing electrical power. Wind energy is free, plentiful, widely distributed, clean, and does not produce unwanted greenhouse gas emissions. Traditionally, wind energy has been converted to electrical energy by large-scale wind farms in which wind turbines convert the wind energy to electrical energy that is fed to the power grid for subsequent distribution to homes, businesses, municipal facilities, schools, hospitals, and the like increasingly, building owners and homeowners are exploring the use of relatively small-scale wind turbines to, provide off-the-grid electrical energy to individualized buildings, homes, or localized groups of buildings.

One of the drawbacks of localized installation of wind turbines to provide off-the-grid electrical power to a home or other building is the initial capital costs. While many governments, including the United States, offer tax incentives or tax rebates for making, such installations, for many, the equipment, installation, and maintenance costs largely outweigh the per/year return on investment associated with operation of such systems. In an effort to improve the viability of localized wind turbine system as a residential alternative energy source, efforts have been made to improve the operating efficiency of such wind turbines. These efforts have included modifications to the turbine construction and/or shroud or, guide structures that are designed and positioned to redirect and/or amply wind directed toward the blades or vanes of the wind turbine.

It has been largely believed that shrouded wind turbines are better able to convert wind energy to electrical power or energy than un-shrouded wind turbines. In fact, some manufacturers of shrouded wind turbines have suggested that their shrouded systems amplify wind speed by as much as twice the ambient wind speed. Amplifying the wind speed in such a manner would cause the rotor of the wind turbine to rotate when ambient unamplified wind speeds may otherwise be insufficient to do so. Testing of exemplary shrouded wind turbine systems has shown that many of the claims regarding improved turbine operation with wind speed amplification cannot be supported. In one experiment, the power output of one shrouded wind turbine was found to be close to the same as the power output of an un-shrouded wind turbine of similar size. Moreover, one tested shrouded wind turbine was found not to produce a positive energy output until an ambient wind speed reached 16 miles per hour (mph).

One skilled in the art would readily appreciate that requiring an ambient wind speed of 16 mph greatly limits the applicability of such a system. This problem of the prior art is particularly problematic given that, for most of the United States, wind speeds at rooftop elevations commonly average less than 12 miles per hour (mph). The testing described above indicates that, although commercial wind turbines are commonly positioned at substantially higher than rooftop elevations, where, greater wind speeds tend to exist, utilization of such improvements at rooftop elevations would increase the cost associated with the wind turbine and only provide a negligible, it any, power generation benefit.

There is therefore a need for an improved residentially available wind turbine assembly that is operable across a wider range of the wind conditions that commonly occur at elevations substantially lower than commercial wind turbine elevations.

The present invention is directed to a method and apparatus of forming a wind turbine assembly that overcomes one or more of the aforementioned drawbacks. In one aspect, wind speed amplification device is disclosed that includes a cone-shaped structure that is positioned adjacent the intake side of an un-shrouded wind turbine. The cone-shaped structure may be free standing or mounted to the frame, housing, or other structure of the wind turbine. The amplification structure is preferably centered about the hub of the rotor on the intake side of the wind turbine, and is designed to redirect wind away from the center portion of the rotor towards more radially outward located portions of the vanes.

It is appreciated that the cone-shaped structure of the amplification device can be provided in number of different angles, as measured as the angle between the outer conic surface and the imaginary axis extending through the vertex from the base of the cone. In one aspect, the angle of the cone is between 10 and 80 degrees. In a more preferred aspect, the angle is between 30 and 60 degrees. Even more preferably, the angle is 50 degrees.

While the amplification device may be cone-shaped, and centrally positioned relative to the rotational axis of the blades of the turbine, the invention is not so limited. In another aspect of the invention, the amplification device takes the form of a structure that is positioned radially outboard relative to the footprint associated with rotation of the turbine blade. In a preferred aspect, such an amplification device is positioned between adjacent wind turbines and/or at alternate lateral sides of each respective wind turbine. The amplification device redirects wind that would otherwise pass between adjacent turbines toward the cross-sectional area associated with rotation of the blades of the respective wind turbine.

In yet a further embodiment, an amplification system is provided in which a diamond or wedge shaped amplification device is, positioned adjacent the intake side of a wind turbine and an amplification structure is mounted between adjacent wind turbines. In a more preferred embodiment, each wedge shaped amplification device includes a forward facing and reward facing wedge portion that extend upstream and downstream, respectively, relative to the respective wind turbine(s).

Therefore, it is one object of the invention to provide an amplification device for use with a wind turbine.

It is another object of the invention to provide a wind turbine system that is operable at rooftop elevations and at reduced wind speeds.

It is yet a further object of the invention to provide a wind energy system capable of providing a meaningful electrical power output during low wind speed conditions.

### BRIEF DESCRIPTION OF THE DRAWINGS

The drawings illustrate the best modes presently contemplated of carrying out the invention.

In the drawings:

FIG. 1 is a front elevation view of a wind turbine usable with the one or more of the amplification apparatus of the present invention;

FIG. 2 is a side elevation view of the wind turbine shown in FIG. 1;

FIG. 3 is a perspective view of the wind turbine shown in FIG. 1 equipped with a wind speed amplification device according to one embodiment of the invention;

FIG. 4 is a top plan view of the assembly shown in FIG. 3;

FIG. 5 is a front elevation view of the assembly shown in FIG. 3;

FIG. 6 is a view similar to FIG. 3 of a wind turbine equipped with a wind speed amplification device according to another embodiment of the present invention;

FIG. 7 is a top plan view of the assembly shown in FIG. 6;

FIG. 8 is a front elevation view of the assembly shown in FIG. 6;

FIG. 9 is a view similar to FIGS. 3 and 6 of a wind turbine equipped with a wind speed amplification device according to another embodiment of the present invention;

FIG. 10 is a top plan view of the assembly shown in FIG. 9;

FIG. 11 is a front elevation view of the assembly shown in FIG. 9;

FIG. 12 is a cross section view of the wind turbine shown in FIG. 1 with a graphical representation of a cross section of the various embodiments of the wind speed amplification devices shown in FIGS. 3-5; 6-9; and 9-11; respectively;

FIG. 13 is perspective view of a wind turbine array equipped with a plurality of wind speed amplification devices according to another embodiment of the invention;

FIG. 14 is a top plan view of the assembly shown in FIG. 13;

FIG. 15 is a front elevation view of the assembly shown in FIG. 14;

FIG. 16 shows an elevation view of a rooftop application associated with implementation of one or more of the wind turbine arrays shown in FIGS. 13-15; and

FIG. 17 is a graph comparing the electrical outputs achievable at various wind speeds of the turbine shown in FIG. 1 when equipped with various wind speed amplification devices as shown in one of more of FIGS. 3-15.

### DETAILED DESCRIPTION OF THE DRAWINGS

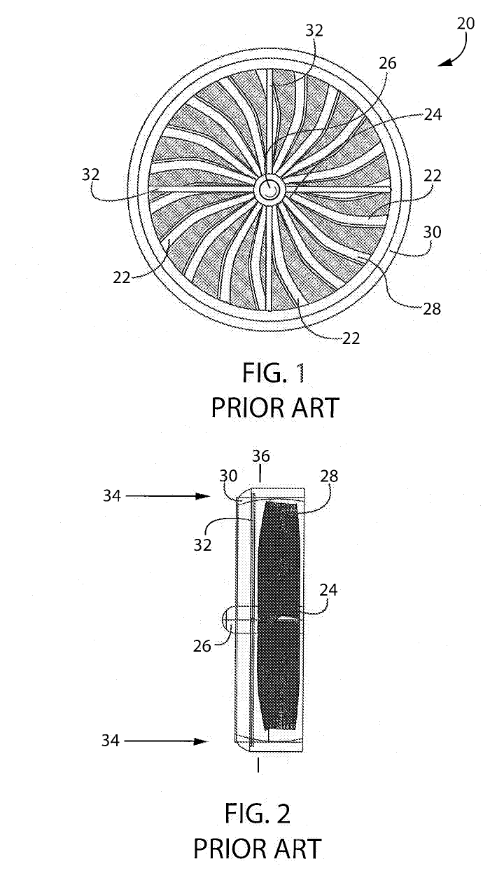

The present invention is directed to a method and apparatus for improving the performance of wind turbines. While the invention is not limited to any particular implementation, the invention will be described with respect to a rooftop mounted wind turbine that rotates about a horizontal axis. However, as will become apparent from the following description, the invention is not limited for use with a specific wind turbine, and similarly can be used with wind turbines that rotate about a vertical axis at locations commonly associated with inoperability of utility power generating wind turbines. Thus, while the invention will be described with respect to an exemplary gearless blade tip wind turbine 20 manufactured by Honeywell International, Inc, as shown and described with respect to FIGS. 1 and 2, it is understood that the invention is applicable to other types of wind turbines intended for use near rooftop elevations or other locations have suitable wind speed and appropriate space.

As shown in FIGS. 1 and 2, turbine 20 includes an array of vanes or number of blades 22 that each have a first or hub end 24 that is rotationally supported by a rotor or hub 26 and a second or tip end 28 that rotationally cooperates with an outer ring 30. Outer ring 30 generally surrounds the outer radial edge of the footprint defined by rotation of the plurality blades 22 about hub 26. A system of magnets and stator coils surround the outer ring 30 such that electrical energy is inductively generated as the tip end 28 of each blade 22 moves past discrete radial locations of outer ring 30. Although wind turbine 20 includes what is termed a blade tip power system, due to the generation of the electrical energy at the radial outer tips of blades 22, it is appreciated that the present invention is equally applicable to more traditional wind turbine constructions, such as those that include a generator or other electrical energy generation device, wherein the electrical energy is generated via a mechanical or inductive interaction disposed nearer the radial center or hub associated with of rotation of the blades of such a turbine assembly. Preferably, wind turbine 20 has a diameter that is between 4 feet and 8 feet and is configured for operation when located at roof top elevations as compared to the substantially greater elevations common to many traditional utility wind turbine applications.

Still referring to FIGS. 1 and 2, regardless of the tip or hub orientation of the electrical energy generation system, hub 26 is constructed to rotationally cooperate with a frame assembly 32 of turbine 20. Hub 26 is sized and constructed to provide sufficient structural integrity to withstand the rotational operation of blades 22 relative to outer ring 30. That is, hub 26 is generally constructed so as to not interfere with the rotational footprint associated with the rotational operation of blades 22. As such, turbine 20 has a blade operational or rotational footprint that extends from a location slightly radially outboard from hub 26 or hub end 24 to locations proximate tip end 28. The, operational footprint of turbine 20 is generally defined by the area of blades 22 that are exposed to a wind stream or wind flow 34 impinged on the blades in directions generally normal to the rotational plane associated with blades 22.

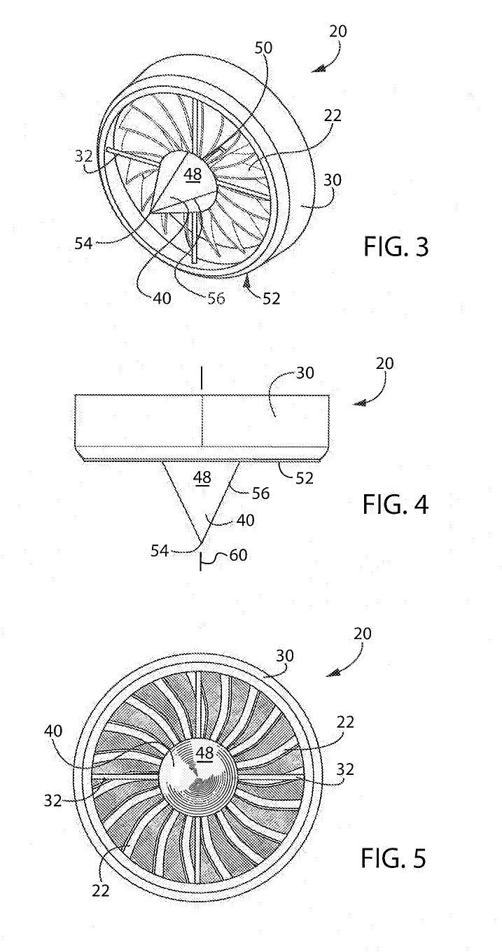

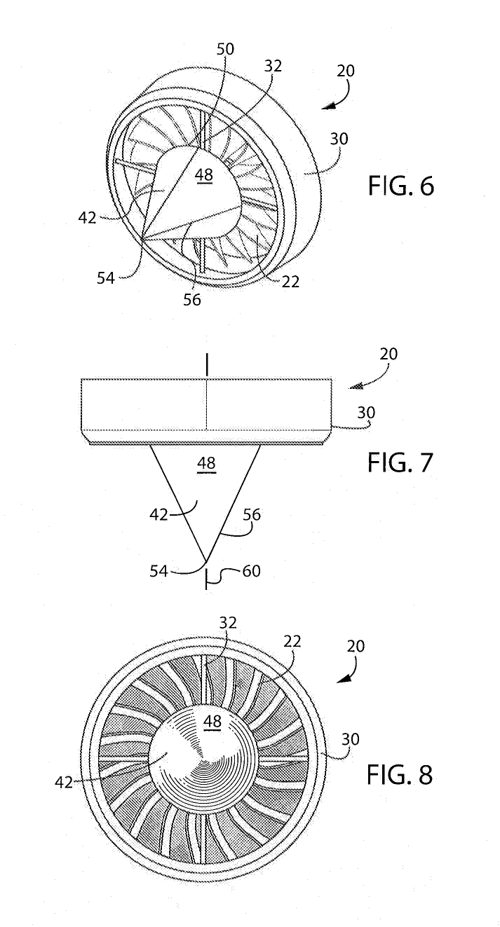

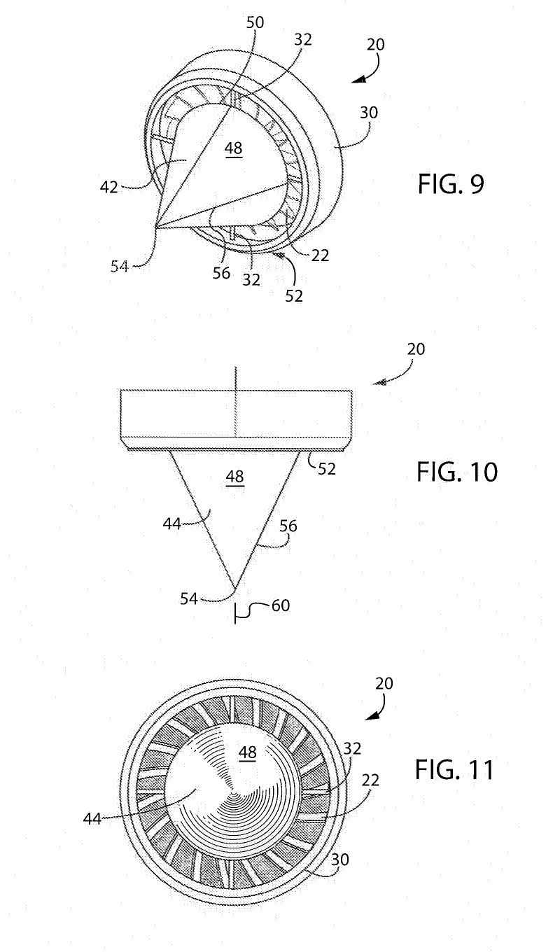

FIGS. 3-12 show various configurations of a wind amplification device 40, 42, 44 according to one embodiment of the present invention. Like reference numerals have been used in FIGS. 3-12 to designate the similar structures associated with amplification devices 40, 42, 44. Each amplification device 40, 42, 44 is formed by a body 48 having a substantially conical shape. Each body 48 has a base or first end 50 that is positioned adjacent in intake side 52 of the respective wind turbine 20 and defines a base associated with, the conical shape of, the respective amplification device 40, 42, 44. A second end 54 of each amplification device forms an apex of body 48 and is offset from first end 50. Second end 54 preferably terminates at a point and is located upstream, relative to wind stream 34, with respect to first end 50 of a respective amplification device 40, 42, 44.

An outer surface 56 of each amplification device 40, 42, 44 extends in a conical shape between base or first end 50 and second or apex end 54. Once oriented relative to wind turbine 20, apex end 54 of each of amplification devices 40, 42, 44 is oriented to be generally aligned with an axis of rotation, indicated by line 60, of plurality of blades 22. The respective amplification device 40, 42, 44 is constructed to be secured to hub 26, frame assembly 32, or independently secured to be positioned forward and concentric relative to hub 26 of the corresponding wind turbine 20 so as to manipulate the cross-sectional footprint associated with directing the wind stream 34 through turbine 20. Although apex end 54 is preferably pointed or substantially pointed, it is appreciated that apex end 54 could be rounded, flat, or have another shape.

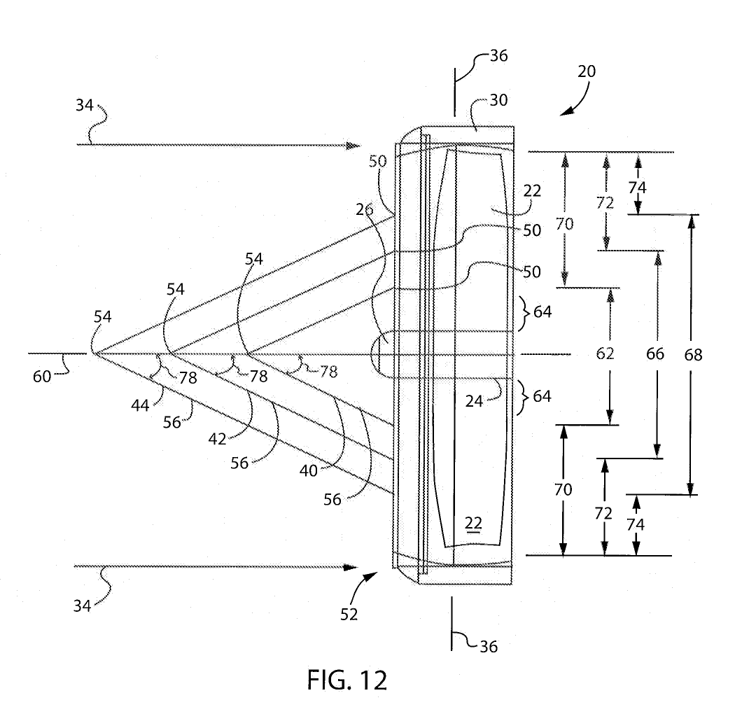

A cross sectional shape of each amplification device 40, 42, 44 is shown graphically in FIG. 12 wherein the cross sections of amplification devices 40, 42, 44 are shown laid over one another for graphical purposes. It should be appreciated that each turbine 20 is configured to cooperate with one of amplifications at any given time although the amplification devices may be interchangeable so as to accommodate changes to the ambient wind conditions over a period of time or during seasonal changes in the magnitude of the prevalent wind conditions.

Still referring to FIG. 12, base or first end 50 of amplification device 40 has a diameter 62 so as to overlie hub 26 and a portion 64 of hub end 24 of each of the plurality of blades 22. Comparatively, base 50 of amplification device 42 has a diameter 66 that is larger than diameter 62 of amplification device 40 such that amplification device 42 obstructs a greater portion of the operational foot print defined by blades 22. Base 50 of amplification device 44 includes a diameter 68 that is larger than both diameter 66 of amplification device 42 and diameter 62 of base 50 of amplification device 40. Accordingly, each of amplification devices 40, 42, 44 interfere with gradually greater portions of wind stream 34 further reducing the operational cross section associated with the plurality of blades 22 that are exposed directly to wind stream 34. Those portions of wind stream 34 that are impinged upon outer surface 56 of one of amplification devices 40, 42, 44 are directed along the outer surface 56 of the respective amplification device 40, 42, 44 and impinge upon blades 22 to define one operational footprint 70 associated with amplification device 40, another operational footprint 72 associated with amplification device 42, and yet another operational footprint 74 associated with amplification device 44.

In a preferred embodiment of the invention, amplification device 40 has a base that is 2 feet in diameter, amplification device 42 has a base that is 3 feet in diameter, and amplification device 44 has a base that is 4 feet in diameter when angle 78 is 50 degrees. As further explained below with respect to the first table, it is appreciated that the measure of angle 78 can be manipulated to provide a body of the respective amplification device with other base and geometric height parameters. Regardless of the specific shape of a particular amplification device, each amplification device 40, 42, 44 overlaps a radially center portion of blades 22 thereby directing a portion of the wind flow 34 associated with the amplification device 40, 41 44 toward that portion of blades 22 that is not obscured by the respective amplification device 40, 42, 44.

Limiting the portion of blades 22 exposed to wind stream 34 concentrates or amplifies the wind stream associated with operational footprint 70, 72, 74 associated with a respective amplification device 40, 42, 44. Such manipulation of wind stream 34 increases the speed of the wind stream as the wind stream travels from the second or apex end 54 of a respective amplification device toward the respective base or first end 50 of the corresponding amplification device 40, 42, 44. Each amplification devices 40, 42, 44 manipulates the wind speed introduced to a respective turbine 20 to allow utilization of wind turbine 20 to generate electrical energy at ambient wind speed conditions that are substantially lower than ambient wind speed conditions required to effectuate operation of wind turbine 20 without utilization of a respective amplification device 40, 42, 44.

Still referring to FIG. 12, outer surface 56 of each body 48 of each amplification device 40, 42, 44 is defined by an angle, indicated by dimension 78, formed between outer surface 56 and axis 60. Although each respective amplification device 40, 42, 44 is shown as having similar angles 78, it is appreciated that the angle 78 associated with amplification devices 40, 42, 44 can be manipulated so as to provide a desired obstruction of wind stream 34 to achieve an operational cross section of blades 22 that is between operating cross sections 70 and 74.

For instance, it is appreciated that angle 78 associated with amplification device 40 can be increased, with or without manipulating the height associated the conical shape, to yield operational cross sections that are between cross sections 70 and 74. Such manipulation would yield an amplification device having an apex that is nearer intake side 52 of wind turbine 20 than, for instance, either of amplification devices 42, 44. Said in another way, the cone shape of any of amplification devices 40, 42, 44 may be constructed such that its size (base radius, r, and cone height, h) as well as the angle 78 between the outer surface 56 of the cone and the vertical axis, h, of the cone provide a desired amplification. The table below shows the results achieved via testing of several conical shaped amplification devices having different angles of cone shape and the resultant percentage of energy increase according to the first embodiment of the present invention attained at wind speeds commonly unsuitable to achieve desired operation of wind turbine 20.

| | | Amplified | | Power |
|---|---|---|---|---|
| | Wind | Wind | Percent | Amplifi- |
| | Speed | Speed | Amplifi- | cation % |
| Geometry | (m/s) | (m/s) | cation | Power Increase |
| Wind Cone - 10° | 2.0 | 2.224 | 11.20 | 37.50 |
| Wind Cone - 20° | 2.0 | 2.301 | 15.05 | 52.29 |
| Wind Cone - 30° | 2.0 | 2.362 | 18.10 | 64.72 |
| Wind Cone - 40° | 2.0 | 2.405 | 20.25 | 73.88 |
| Wind Cone - 45° | 2.0 | 2.410 | 20.50 | 74.97 |
| Wind Cone - 50° | 2.0 | 2.412 | 20.60 | 75.40 |
| Wind Cone - 55° | 2.0 | 2.388 | 19.40 | 70.22 |
| Wind Cone - 60° | 2.0 | 2.358 | 17.88 | 63.78 |

From the data above, it is clear that the wind cone with a 50 degree angle was found to provide the largest power amplification percent at a wind speed of 2.0 m/s. It is understood that the wind cones could be tested under other wind speeds and known statistical analyses could be used to determine the optimal wind cone shape, and size, for a particular wind turbine or common ambient conditions associated with the intended use of the respective turbine 20. It is further appreciated that any of amplification devices 40, 42, 44 can be formed of any material but, due to exposure to atmosphere, each of amplification devices 40, 42, 44 are preferably formed from corrosion resistant material.

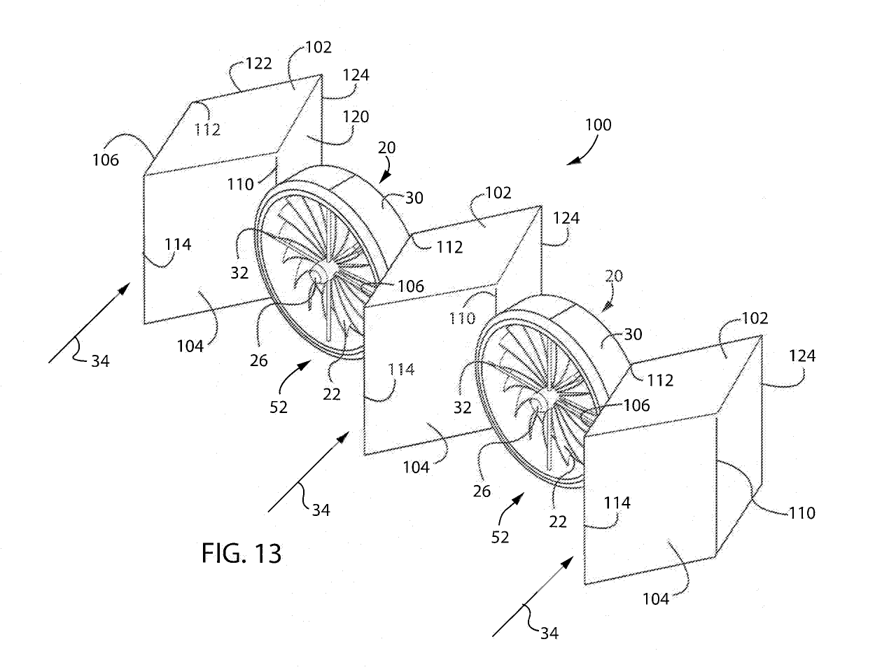

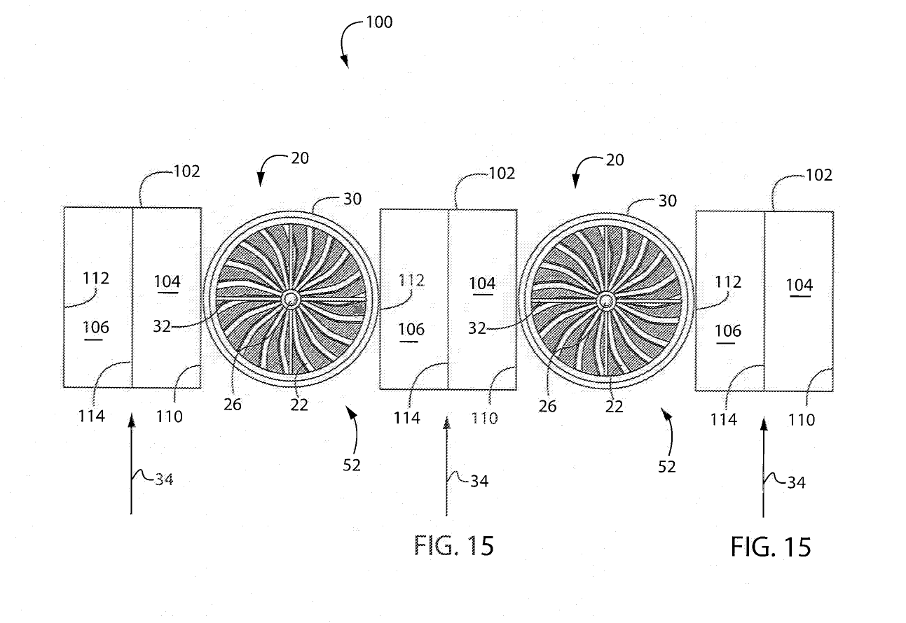

FIG. 13-15 show a wind turbine system 100 that includes a number of wind speed amplification devices 102 according to another embodiment of the invention. It should be appreciated that whereas amplification devices 40, 42, 44 have a substantially conical shape and are oriented proximate the hub 26 of a respective turbine 20, amplification devices 102 have a generally block or wedge shape and preferably include a forward extending wedge portion and a rearward extending wedge portion relative to a respective turbine and the orientation of the turbine and the amplification device(s) relative to the wind flow 34.

System 100 includes one or more wind turbines 20 that each include a plurality of blades 22 that are rotatably supported by hub 26 and disposed radially inward of the outer ring 30. One or more frame members 32 extend between outer ring 30 and hub 26. Each amplification device 102 includes a first deflection wall 104 and the second deflection wall 106 that are shaped to define a first wedge that extends upstream relative to wind stream 34 with respect to the intake side 52 of the respective turbines 20.

Each deflection wall 104, 106 includes a first edge 110, 112 and a second edge 114. First edge 110 of first deflection wall 104 is offset from the first edge 112 associated with second deflection wall 106 such that the first edges 110, 112 define non-common edges of deflection walls 104, 106. Edge 114 is offset forward or upstream from the generally vertical plane 118 associated with system 100 relative to wind flow 34 so as to define a common edge of deflection walls 104, 106. Each amplification device 102 includes a third, deflection wall 120 and a fourth deflection wall 122 that extend in a generally rearward or downstream direction from edges 110, 112 associated with respective deflection walls 104, 106. As such, edges 110, 112 associated with first deflection wall 104 and second deflection wall 106 define non-common edges of third deflection wall 120 and fourth deflection wall 122. Third and fourth deflection walls 120, 122 intersect one another at a common edge 124 that is oriented rearward of plane 118 of turbine 20 and relative to wind flow 34.

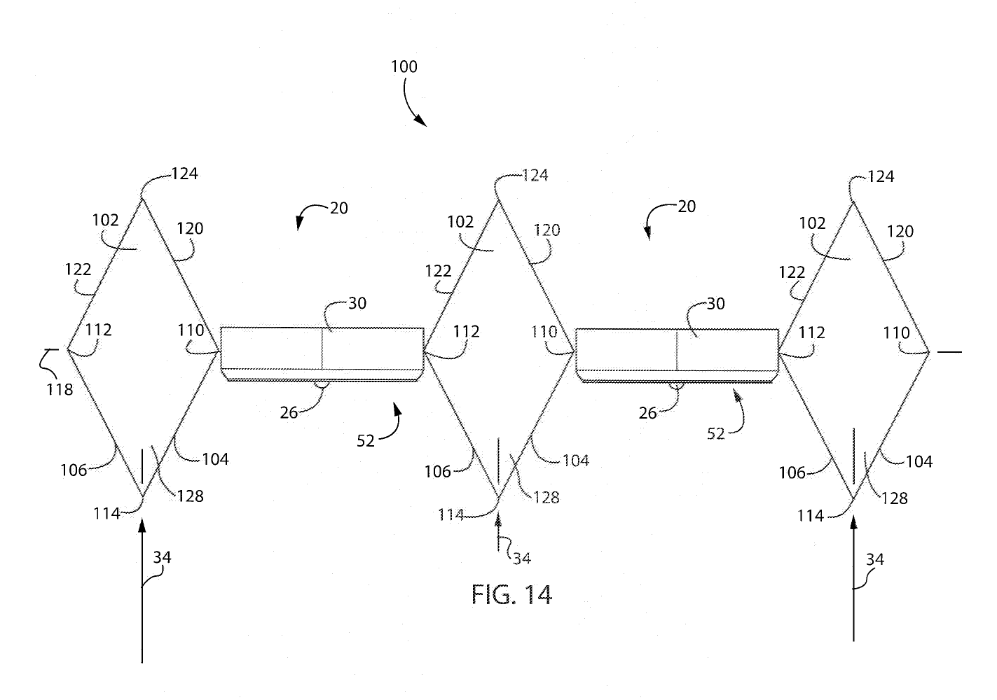

Referring to FIG. 14, wind flow 34 impinged upon common, edge 114 is directed by deflection walls 104, 106 toward wind turbines 20 disposed on generally opposite sides of the respective amplification device 102 and toward the operational footprint associated with rotation of blades 22. As such, amplification devices 102 increase the footprint associated with operation of turbine 20 to accommodate utilization of that portion of wind flow 34 that is between adjacent common edges 114 of associated adjacent amplification devices 102 as compared to solely the cross section of the operational footprint of blades 22. Although FIGS. 13-15 include two wind turbines 20 that are each disposed between adjacent amplification devices 102, is appreciated that utilization of one or preferably two amplification devices 102 on generally opposite lateral sides of a respective turbine 20 increases the wind flow and wind speed directed toward a respective wind turbine 20 such that a respective turbine 20 can generate electrical power at wind speeds that are below the operational wind speed associated with a respective turbine 20 without utilization of amplification devices 102.

Still referring to FIG. 14, first deflection wall 104 and second, deflection wall 106 are generally mirror images of third deflection wall 120 and fourth deflection wall 122, respectively with respect to a plane that extends between edges 110, 112 of a respective amplification device 102. It should further be appreciated that first deflection wall 104 and third deflection wall 120 are configured as mirror images relative to second deflection wall 106 and fourth deflection wall 122 relative to a plane that extends between common edges 114, 124 of a respective amplification device 102.

Like amplification devices 40, 42, 44 shown in FIGS. 3-12, it is further appreciated that angle 128 between deflection walls 104, 106 of the respective amplification device 102 relative to a longitudinal axis that extends between common edge 114, 124 can be manipulated to achieve a desired width of amplification device 102. That is, the distance between non-common edges 110, 112 which is contained in plane 118, and the apex associated with common edge 114, 124 of the forward wedge portion associated with deflection walls 104, 106, or a rearward wedge portion, associated with deflection walls 120, 122 of deflection devices 102, can be manipulated to achieve a wider and/or shorter amplification device 102 to accommodate various distances formed between adjacent wind turbines 20.

In a preferred embodiment of the invention, amplification devices 102 have a vertical height that approximates the vertical height of a respective turbine 20. In a preferred embodiment, amplification devices 102 are approximately 6 feet tall or generally extend in a vertical direction so as to extend the vertical direction associated with the vertical dimension of the foot print associated with operation of a given turbine. It is further appreciated that such an amplification device can be provided with approximately 8 feet 6 inches between common or apex edges 114, 120 and nearly 4 feet between non-common edges 110, 112. It is appreciated that such dimensions may vary as a function of the size and spacing associated with a respective array of one or more of turbines 20 and/or the dimensions of the respective turbine 20.

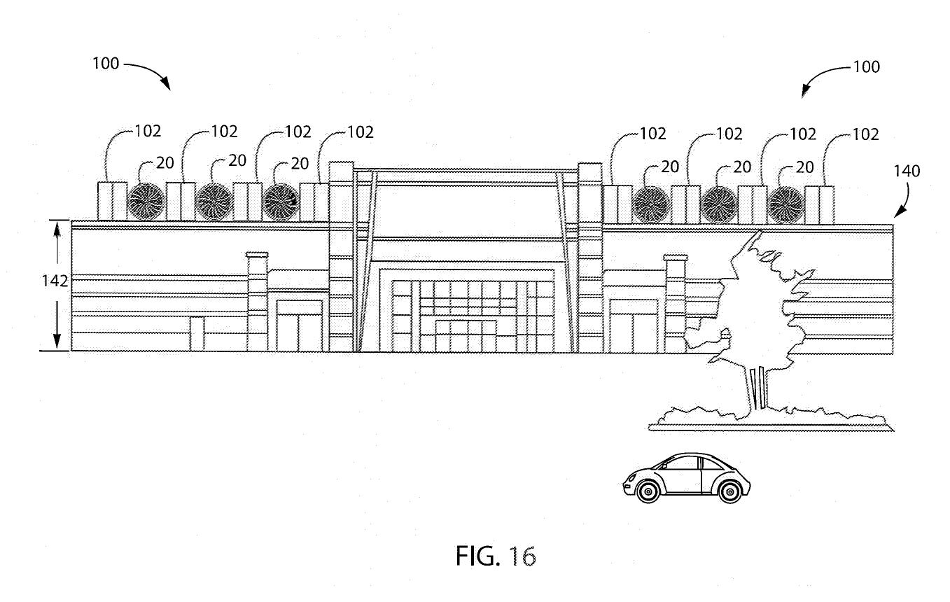

FIG. 16 shows an exemplary facility 140 having a plurality of wind turbine systems 100 that each include a plurality of turbines 20 disposed between adjacent amplification devices 102. Systems 100 are positioned at a rooftop elevation 142 of facility 140. Preferably, system 100 is disposed about at least a portion of a horizontal footprint associated with facility 140. More preferably, systems 100 are disposed along those portions of the perimeter of facility 140 that are associated with the prevailing ambient wind conditions particular to a geographical orientation and location of facility 140. Preferably the electrical output associated with each turbine 20 is connected so as to provide a unitary or collective output associated with operations of turbines 20. Alternatively, the output of one or more of turbines 20 may be communicated to discrete electrical systems configured for operation with the electrical output associated with one or more of turbines 20.

It should be appreciated that facility 140 can be configured to benefit from the use of one or any number of turbines 20 and a corresponding number of amplification devices 102. Preferably, the number of amplification devices 102 is at least one greater than the number of turbines 100 associated with the respective system 100 such that each turbine 20 is flanked or otherwise disposed between a pair of adjacent amplification devices 102. It is further appreciated that one or more of turbines 20 can be configured to cooperate with a respective amplification device 40, 42, 44 as well as one or more amplification devices 102. Such a configuration further improves the operational range of a respective wind energy system relative to ambient wind speed conditions and allows utilization of wind, power based electrical power generation at conditions that may not otherwise satisfy the suitable minimum wind speeds associated with operation of unamplified turbine 20.

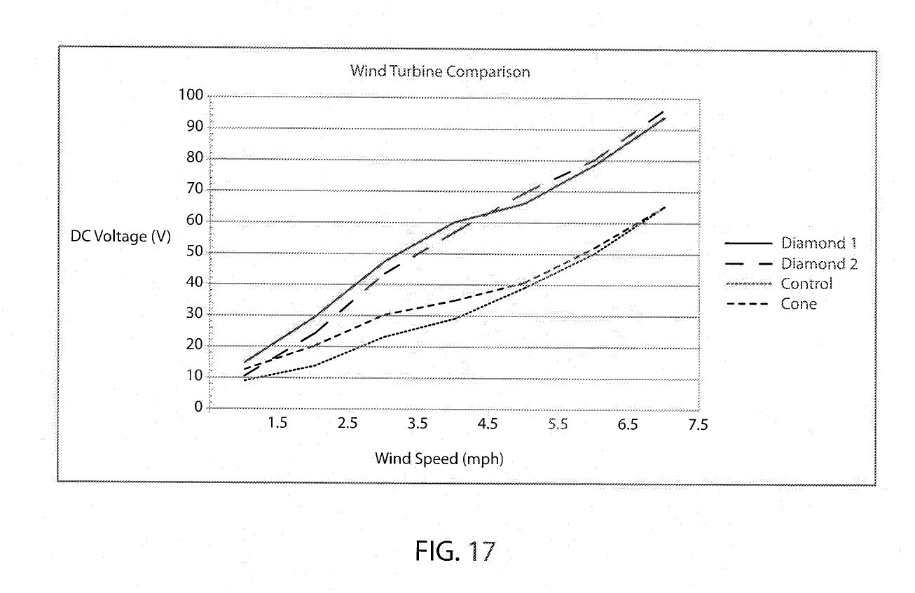

FIG. 17 compares the electrical output, as a direct-current voltage value, that can be achieved with wind turbine 20 without any of amplification devices 40, 42, 44, 102, (indicated as the Control trend plot), to the electrical outputs that can be achieved when the turbine 20 is equipped with one of amplifications devices 40, 42, 44, (indicated as the Cone trend plot), and a wind turbine equipped with one or two of amplification devices 102, (indicated by Diamond 1 and Diamond 2 trend plots). As shown in FIG. 17, equipping wind turbines 20 with any of amplification devices 40, 42, 44, 102 increases the electrical output that can be achieved with wind turbines 20 at wind speeds between approximately 1 and 7 miles per hour thereby improving the range of usable operation of wind turbines 20. The empirical data associated with the plots shown in FIG. 17 are presented below.

| Wind Speed | Diamond 1 | Diamond 2 | Control | Cone |
|---|---|---|---|---|
| 1.50 | 14.84 | 10.49 | 9.03 | 12.64 |
| 2.50 | 29.46 | 24.12 | 13.86 | 20.25 |
| 3.50 | 47.58 | 43.64 | 23.19 | 30.29 |
| 4.50 | 60.19 | 57.04 | 29.07 | 34.89 |
| 5.50 | 66.19 | 69.57 | 39.06 | 40.78 |
| 6.50 | 78.50 | 80.22 | 50.23 | 52.08 |
| 7.50 | 93.84 | 96.31 | 65.21 | 65.29 |

As evidenced by the data provided above, equipping a wind turbine 20 with one of amplification devices 40, 42, 44 and/or one or more of amplification devices 102 allows utilization of the wind turbine at wind conditions that would otherwise be unsuitable or incapable of generating a desired operation of the wind turbine to generate electrical power. Accordingly, each of amplification devices 40, 42, 44, 102 increases the range of operation of a given wind turbine thereby improving the return on investment associated with utilization of such systems.

Therefore, one, embodiment of the invention includes an apparatus for amplifying a speed of a wind stream directed at a wind turbine that is operable at rooftop elevations. The apparatus includes a body having a first end and a second end wherein the first end is positioned adjacent an intake side of the wind turbine and the second end is displaced upstream relative to a wind direction from the first end. An outer surface of the body is configured to increase the speed of the wind stream that strikes the outer surface as the wind stream travels from the second end toward the first end of the body and redirect the wind steam toward a blade area of the wind turbine.

Another embodiment of the invention that is usable with one or more features of the above embodiment includes a system for generating electrical power from wind energy occurring proximate rooftop elevations. The system includes a first wind turbine and a second wind turbine that each includes a plurality of blades that are independently rotatable relative to the blades of the other wind turbine. The first and second wind turbines are mountable to a building structure such that a space is formed between the first and second wind turbines. A wind speed amplifier is disposed in the space between the first and second wind turbines. The wind speed amplifier has a wedge-shaped cross section relative to a plane that intersects the first and second wind turbines. The wedge-shaped cross section has a base that is nearer the first and second wind turbines and an apex that is offset in a direction of wind flow relative to the first and second wind turbines to amplify wind stream energy directed toward the first and second wind turbines.

Another embodiment of the invention that is usable with one or more features of the above embodiments includes a system for amplifying ambient wind speed communicated to a rooftop elevation wind turbine system. The system includes a wedge having a first deflection wall and a second deflection wall. The first deflection wall and the second deflection wall intersect at a forward common edge. Each of the first deflection wall and the second deflection wall have a non-common edge that is spaced from the non-common edge of the other of the first deflection wall and the second deflection wall such that, when the non-common edge of one of the first deflection wall or the second deflection wall, is positioned adjacent a wind turbine, the forward common edge is spaced radially outward and longitudinally forward of an area of rotation, of a plurality of blades of the wind turbine. The system includes a hub amplifier having a conical shape defined by a base shaped to be disposed adjacent an inlet side of the wind turbine and an apex that is offset longitudinally from the base along an axis of rotation of the plurality of blades of the wind turbine.

Many changes and modifications could be made to the invention without departing from the spirit thereof The scope of these changes will become apparent from the appended claims.

What is claimed is:

1. An apparatus for amplifying a speed of a wind stream directed at a wind turbine, the apparatus comprising:
a body having a first end and a second end, the first end positioned adjacent an intake side of the wind turbine and the second end displaced upstream relative to a wind direction from the first end; and
an outer surface of the body configured to increase the speed of the wind stream that strikes the outer surface as the wind stream travels from the second end toward the first end of the body and redirect the wind steam, toward a blade area of the wind turbine.

2. The apparatus of claim 1 wherein the first end of the body defines a base that is mounted adjacent the intake side of the wind turbine such that the body is at least one of centered about a hub of the wind turbine and offset radially outward from the blade area

3. The apparatus of claim 2 wherein the base has a footprint that envelopes the hub when the body is centered about the hub.

4. The apparatus of, claim 1 wherein the body is a cone having a base formed at the first end, a vertex formed at the second end, and a conical surface extending between the base and the vertex, the base positioned adjacent the intake side of the wind turbine and the vertex spaced from the wind turbine by the conical surface; and
the conical surface having an angle, as measured between an imaginary line that passes through a center of the base and the vertex and a line that is contained in a plane of the conical surface and parallel to the imaginary line, between 10 degrees and 60 degrees.

5. The apparatus of claim 4 wherein the angle is between 40 degrees and 55 degrees.

6. The apparatus of claim 5 wherein the angle is 50 degrees.

7. The apparatus of claim 1 wherein the body has a cone shape.

8. The apparatus of claim 1 wherein the body is wedge shaped and offset to a lateral side relative to the wind stream that overlies the blade area of the wind turbine.

9. A system for generating electrical power from wind energy, the system comprising:
a first wind turbine that includes a plurality of blades;
a second wind turbine that includes a plurality blades that are independently rotatable relative to the plurality of blades of the first wind turbine, the first and second wind turbines being mountable to a building structure such that a space is formed between the first and second wind turbines; and
a wind speed amplifier disposed in the space between the first and second wind turbines, the wind speed amplifier having a wedge-shaped cross section relative to a plane that intersects the first and second wind turbines, the wedge-shaped cross section having a base that is nearer the first and second wind turbines and an apex that is offset in a direction of wind flow relative to the first and second wind turbines to amplify wind stream energy directed toward the first and second wind turbines.

10. The system of claim 9 wherein wind speed amplifier is further defined as a first wedge having an edge located upstream of the first and second wind turbines relative to a wind flow directed through the first and second wind turbines and a second wedge having an, edge that is located downstream of the first wedge and the first and second wind turbines relative to the wind flow.

11. The system of claim 10 wherein a shortest distance between the edge of the first wedge and the edge of the second wedge is less than a longitudinal length of either edge.

12. The system of claim 11 wherein a shortest distance of the space is less than the shortest distance between the edge of the first wedge and the edge of the second wedge.

13. The system, of claim 9 further comprising a third wind turbine and another wind speed amplifier disposed in a space between the third wind turbine and an adjacent one of the first wind turbine or the second wind turbine.

14. The system of claim 9 wherein the first wind turbine and the second wind turbine generate electrical power at an outward radial tip of each of the plurality of blades.

15. The system of claim 9 further comprising a hub wind speed amplifier disposed at a rotational center of the plurality of blades of each of the first wind turbine and the second wind turbine, each hub wind speed amplifier having a conical shape defined by a base positioned adjacent the respective plurality of blades and an apex positioned upstream relative to the base.

16. The system of claim 15 wherein each hub wind speed amplifier has a conical surface that is oriented at an angle of 50 degrees relative to a geometric height of the respective conical surface.

17. A system for amplifying ambient wind speed communicated to a wind turbine system, the system comprising:
a wedge having a first deflection wail and a second deflection wall, the first deflection wall and the second deflection wall intersecting at a forward, common edge, each of the first deflection wall and the second deflection wall having a non-common edge that is spaced from the non-common edge of the other of the first deflection wall and the second deflection such that, when the non-common edge of one of the first deflection wall or the second deflection wall is positioned adjacent a wind turbine, the forward common edge is spaced radially outward and longitudinally forward of an area of rotation of a plurality of blades of the wind turbine; and
a hub amplifier having a conical shape defined by, a base shaped to be disposed adjacent an inlet side of the wind turbine and an apex that is offset longitudinally from the base along an axis of rotation of the plurality of blades of the wind turbine.

18. The system of claim 17 wherein the wedge further comprises a third deflection wall and a fourth deflection wall that intersect at a rearward common edge, each of the third deflection wall and the fourth deflection wall having a non-common edge that is spaced from the non-common edge of the other of the third deflection wall and the fourth deflection wall such that, when the non-common edge of one of the third deflection wall or the fourth deflection wall is positioned adjacent a wind turbine, the rearward common edge is spaced radially outward and longitudinally rearward of the area of rotation of the plurality of blades of the wind turbine

19. The system of claim 18 wherein the first deflection wall and the third deflection wall are a mirror image of the second deflection wall and the fourth deflection wall along a plane that extends between the forward common edge and the rearward common edge, and the first and second deflection walls are another mirror image of the third and fourth deflection walls along a plane that is located at a mid-point and perpendicular to the plane between the forward common edge and the, rearward common edge.

20. The system of claim 18 further comprising a plurality of wedges and a plurality of wind turbines, wherein a number of the plurality of wedges is one greater than a number of the plurality of wind turbines, the number of wind turbines and the number of wedges being arranged so that each wind turbine is flanked on at least two opposite sides of the wind turbine by adjacent wedges.

21. The system of claim 20 further comprising a plurality of hub amplifiers, wherein a number of the plurality of hub amplifiers is equal to the number of plurality of wind turbines.

22. The system of claim 21 wherein the conical shape of each hub amplifier is oriented at an angle from 40 degrees to 55 degrees relative to a geometric height associated with the conical shape of the respective hub amplifier.
